(19) United States
(12) Patent Application Publication
(10) Pub. No.: US 2018/0147987 A1
(43) Pub. Date: May 31, 2018

(54) VEHICLE DISPLAY SYSTEM AND METHOD FOR CONTROLLING VEHICLE DISPLAY SYSTEM

(71) Applicant: Toyota Jidosha Kabushiki Kaisha, Toyota-shi Aichi-ken (JP)

(72) Inventor: Masanori Kushibe, Toyota-shi (JP)

(21) Appl. No.: 15/817,762

(22) Filed: Nov. 20, 2017

(30) Foreign Application Priority Data
Nov. 25, 2016 (JP) 2016-229532

(51) Int. Cl. B60R 1/00; H04N 17/04; H04N 7/18; H04N 5/445

(52) U.S. Cl. CPC B60R 1/00; H04N 17/04; H04N 7/18; H04N 5/232; B60R 2300/207; B60R 2300/8046; H04N 5/44504

(57) ABSTRACT

A vehicle display system includes a display unit, a camera controller, and a media controller. When the vehicle display system is in a normal mode, the display unit shows an output image of the camera controller if a transmission of a vehicle is in a reverse gear, and shows an output image of the media controller if the transmission of the vehicle is not in the reverse gear. When the vehicle display system is in a test mode, the display unit shows a test image selected by the media controller regardless of whether or not the transmission of the vehicle is in the reverse gear.

### CROSS-REFERENCE TO RELATED APPLICATIONS

This application claims priority to Japanese Patent Application No. 2016-229532 filed Nov. 25, 2016, the entire contents of which is incorporated herein by reference.

### BACKGROUND

The present disclosure relates to a vehicle display system including a display unit that shows an image containing a rearward view of a vehicle. The present disclosure also relates to a method for controlling a vehicle display system.

One example of a vehicle display system includes a camera, which captures an image of the rear side of a vehicle, and a display unit. When the vehicle display system detects that the transmission of the vehicle is shifted to the reverse gear, the vehicle display system shows a rearward view of the vehicle captured by the camera on the display unit.

Additionally, the vehicle display system may show vehicle information on the display unit. The vehicle display system includes a display ECU. The display ECU switches the image shown on the display unit between the rearward view of the vehicle and an image of the vehicle information. Thus, if the display ECU is defective or erroneously actuated, the display unit may fail to show the rearward view of the vehicle when the transmission of the vehicle is shifted, to the reverse gear. In this regard, Japanese Laid-open Patent Publication No. 2007-145241 describes one example of a vehicle display system, capable of showing a rearward view of a vehicle on a display unit even when a display ECU is, for example, defective.

In the above vehicle display system, when the ignition switch is switched on, the display unit is powered and actuated by a power supply regardless of the actuation state or the display ECU. Thus, even when the display ECU is defective, if the driver shifts the transmission to the reverse gear, the display unit shows the rearward view of the vehicle captured by the camera.

To ensure vehicle travel safety and comply with laws and regulations, a known vehicle display system shows a rearward view of the vehicle on the display unit whenever the transmission is shifted to the reverse gear.

When a vehicle including such a vehicle display system is tested at a dealer or a testing facility, that is, when the vehicle is not in a travel state, the vehicle display system shows a testing picture on the display unit. However, when the transmission is shifted to the reverse gear, the testing picture is switched to the rearward view of the vehicle on the display unit. This may increase the burden of testing.

### SUMMARY

It is an object of the present disclosure to provide a vehicle display system capable of maintaining presentation of a picture shown on a display unit of a vehicle when the vehicle is tested regardless of whether or not a transmission is shifted to a reverse gear.

To achieve the above object, a vehicle display system includes a display unit configured to show an image, a camera controller configured to output an image containing a rearward view of a vehicle captured by an onboard camera, to the display unit, and a media controller configured to output an image that does not contain the rearward view of the vehicle to the display unit. The vehicle display system operates in a normal mode in which the vehicle is travelable and a test mode that differs from the normal mode. When the vehicle display system is in the normal mode, the display unit is configured to show the output image of the camera controller if the display unit receives a signal indicating that a transmission of the vehicle is in a reverse gear through a signal line, and show the output image of the media controller if the display unit receives a signal indicating that the transmission of the vehicle is not in the reverse gear through the signal line. When the vehicle display system is in the test mode, the display unit is configured to show one of the output image of the camera controller and the output image of the media controller that is selected by the media controller regardless of a signal received through the signal line.

To achieve the above object, a method for controlling a vehicle display system that operates in a normal mode in which a vehicle is travelable and a test mode that differs from the normal mode includes showing an image containing a rearward view of the vehicle captured by an onboard camera on a display in accordance with a reception of a signal indicating that a transmission of the vehicle is in a reverse gear through a signal line when the vehicle display system is in the normal mode, showing an image that does not contain the rearward view of the vehicle on the display in accordance with a reception of a signal indicating that the transmission of the vehicle is not in the reverse gear through the signal line when the vehicle display system is in the normal mode, and showing an image for the test mode on the display regardless of a signal obtained through the signal line when the vehicle display system is in the test mode.

To achieve the above object, a vehicle display system operates in a normal mode in which a vehicle is travelable and a test mode that differs from the normal mode. The vehicle display system includes a display configured to show an image and circuitry. When the vehicle display system is in the normal mode, the circuitry is configured to show an image containing a rearward view of the vehicle captured by an onboard camera on the display if the circuitry receives a signal indicating that a transmission of the vehicle is in a reverse gear through a signal line. When the vehicle display system is the normal mode, the circuitry is configured to show an image that does not contain the rearward view of the vehicle on the display if the circuitry receives a signal indicating that the transmission of the vehicle is not in the reverse gear through the signal line. When the vehicle display system is in the test mode, the circuitry is configured to show an image for the test mode on the display regardless of a signal obtained through the signal line.

Other aspects and advantages of the present disclosure will become apparent from the following description, taken in conjunction with the accompanying drawings, illustrating by way of example the principles of the present disclosure.

### BRIEF DESCRIPTION OF THE DRAWINGS

The embodiments of the present disclosure, together with objects and advantages thereof, may best be understood by reference to the following description of the presently preferred embodiments together with the accompanying drawings in which:

FIG. 1 is a schematic block diagram showing the configuration of one embodiment of a vehicle display system;

FIG. 2 is a list of kinds of images shown on a display when the vehicle display system of FIG. 1 is in a normal mode;

FIG. 3 is a list of kinds of images shows on the display when the vehicle display system of FIG. 1 is in a test mode;

FIG. 4 is a flowchart showing the procedures of a process for switching an image in the vehicle display system of FIG. 1; and

FIG. 5 is a schematic block diagram showing the configuration of another embodiment of a vehicle display system.

### DETAILED DESCRIPTION

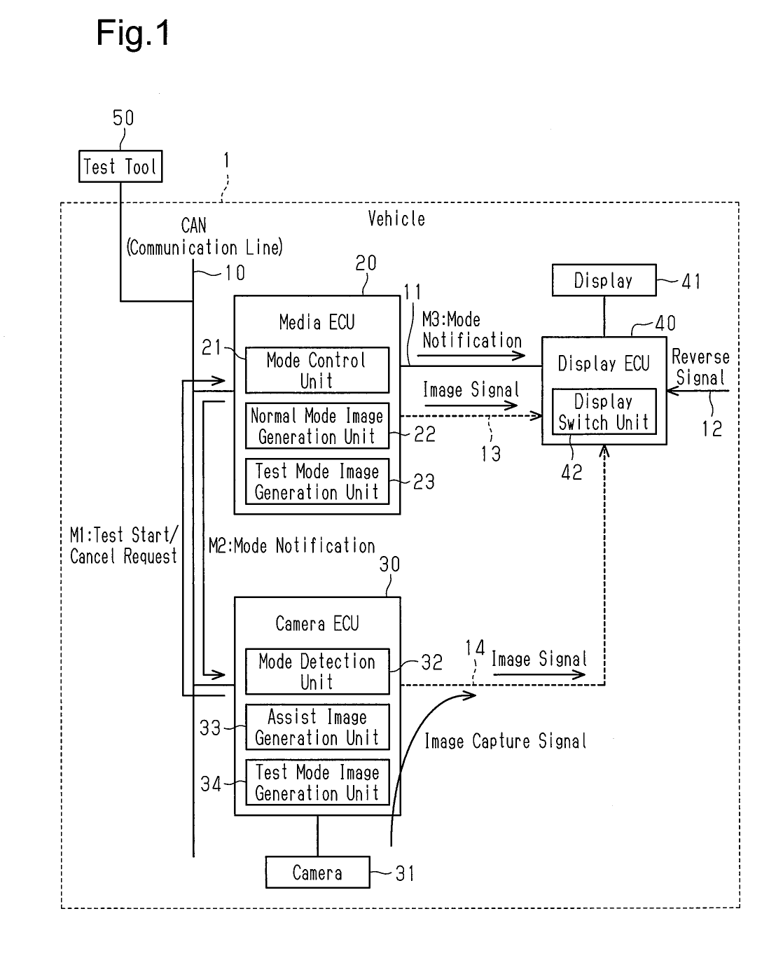

One embodiment of a vehicle display system will now be described with reference to FIGS. 1 to 4. The present embodiment of the vehicle display system has an onboard network configured in a vehicle 1.

The present embodiment of the vehicle display system will new be schematically described with reference to FIG 1.

The vehicle display system includes a media ECU 20, which functions as a media controller, and a camera ECU 30, which functions as a camera controller. A test tool 50, which functions as a test device that sets, for example, the two ECUs 20, 30 to a test mode, may be connected to the vehicle display system in a removable manner. More specifically, the test tool 50 is normally disconnected from the two ECUs 20, 30. The best tool 50 is connected to the two ECUs 20, 30 only when the vehicle needs to be tested. The vehicle display system further includes a display ECU 40, which controls presentations of images output by the media ECU 20 and the camera ECU 30. The display ECU 40 functions as a display controller. The present embodiment of a display unit includes the display ECU 40 and a display 41. The media ECU 20 and the camera ECU 30 are capable of outputting an image to the display ECU 40. The display 41 is capable of showing the image.

The test tool 50 is a device used to test vehicles at a dealer or a testing facility. When the test tool 50 is connected to the onboard network and activates the test mode, the media ECU 20 and the camera ECU 50 detect that the test mode is activated via the onboard network and are set to the test mode. The media ECU 20 and camera ECU 30 are normally set to a normal mode. The media ECU 20 and the camera ECU 30 are set to the test mode only during a test. Additionally, when the vehicle 1 is travelable by a driving operation, the media ECU 20 and the camera ECU 30 are always set to the normal mode. That is, the vehicle display system, which includes the media ECU 20 and the camera ECU 30, operates in the normal mode, in which the vehicle 1 is travelable, and the test mode, which differs from the normal mode.

The test mode is canceled from the media ECU 20 and the camera ECU 30 based on a cancelation of the test mode in the test tool 50 or a condition that may complete the test. The display ECU 40 receives a reverse signal, which indicates that the transmission is in the reverse gear, via a dedicated signal line 12 to limit an occurrence of a response delay or the like. The display ECU 40 also receives a signal indicating whether the media ECU 20 (vehicle display system) is in the normal mode or the test mode from the media ECU 20. When the media ECU 20 (vehicle display system) is in the normal mode the display ECU 40 switches the presentation between the output image of the media ECU 20 and the output image of the camera ECU 30 based on the reverse signal, which is transmitted through the signal line 12. When the media ECU 20 (vehicle display system) is in the test mode, the display ECU 40 shows one of the output image of the media ECU 20 and the output image of the camera ECU 30 on the display 41 based on a selection of the media ECU 20 regardless of the reverse signal transmitted through the signal line 12.

In the normal mode, the media ECU 20 outputs an image that does not contain a rearward view of the vehicle, for example, an image showing a vehicle state or an image showing a media state. In the test mode, the media ECU 20 outputs an image, for example, allowing for verifying and/or setting of the media state or verifying and/or setting of the vehicle state. Additionally, in the test mode, the media ECU 20 selects whether or not to show the output image of the camera ECU 30 on the display 41 and notifies the selection to the display ECU 40. When the output image of the camera ECU 30 is not selected, the display 41 shows the output image of the media ECU 20. In the normal mode, the camera ECU 30 outputs an image containing the rearward view of the vehicle 1 captured by a camera 31 to the display ECU 40. In the test mode, the camera ECU 30 outputs a test image to the display ECU 40.

The vehicle display system of the present embodiment will now be described in detail with reference to FIG. 1.

The vehicle display system includes a communication bus 10 used for the onboard network. The communication bus 10 is connected to the media ECU 20, the camera ECU 30, and the test tool 50 so as to communicate with each other. Additionally, the media ECU 20 and the camera ECU 30 are connected to the display ECU 40 by image signal lines 13, 14, respectively. The media ECU 20 is connected to the display ECU 40 by an information communication line 11. The media ECU 20, the camera ECU 30, and the test tool 50 are capable of transmitting and receiving various kinds of communication messages to and from each other via the communication bus 10 and also capable of transmitting and receiving various kinds of communication messages to and from other ECUS and the like. The test tool 50 may be connected to the communication bus 10 only when needed for testing.

The communication bus 10 uses, for example, a controller area network (CAN) protocol as the communication protocol. The communication path of the communication bus 10 may partially include a wireless communication path or a path connected via another network by a gateway or the like.

The information communication line 11 uses, for example, a LAN complying with an Ethernet (registered trademark) standard. The communication path of the information communication line 11 may partially include a wireless communication path or a path connected via another network by a gateway or the like.

The image signal lines 13, 14 may each be a line dedicated to image transmission or a signal line that uses a network capable of transmitting image information.

The media ECU 20, the camera ECU 30, and the test tool 50 include, for example, a communication I/F for the CAN protocol and a plurality of MessageBoxs (MBOXs) that temporarily stores communication messages, which are not shown in the drawings. The media ECU 20, the camera ECU 30, and the test tool 50 transmit and receive the communication messages via the communication I/F and the MBOXs.

Each of the media ECU 20, the camera ECU 30, the display ECU 40, and the test tool 50 includes a microcomputer having an arithmetic unit (CPU) and a memory unit. The arithmetic unit executes arithmetic processes in accordance with programs. More specifically, the arithmetic unit may be configured as circuitry that includes 1) one or more dedicated hardware circuits such as ASICs, 2) one or more processors actuated in accordance with comparer programs (software), or 3) the combination of these. The memory unit may include a read-only memory (ROM), which stores, for example, programs and data, and a volatile memory (RAM), which temporarily stores arithmetic results of the arithmetic unit. The memory unit, or a computer readable medium, includes any applicable medium that is accessible by a versatile or dedicated computer. Additionally, the above components such, as the media ECU 20 include a memory unit such as a backup memory, which stores and maintains setting values and arithmetic values when power is constantly supplied from a battery, and a flash memory, which holds data or the like. The above components such as the media ECU 20 retrieve a program from the memory unit to the arithmetic unit and execute the program to provide a particular function. For example, the media ECU 20 and the camera ECU 30 execute a process for outputting an image and a process for obtaining an operation corresponding to the image. The display ECU 40 executes a process for inputting and outputting an image. The test tool 50 sets and/or cancels a process necessary for a test.

The test tool 50 is a device used in a vehicle test conducted based on vehicle information obtained via the communication bus 10. When the vehicle 1 is incapable of traveling, the test tool 50 is connected to the communication bus 10 at a dealer or a testing facility. The test tool 50 is capable of setting and canceling the test mode for each of the ECUs 20, 30 that are connected to the communication bus 10. The cancelation of the test mode automatically sets the ECUs 20, 30 to the normal mode.

The media ECU 20 and the camera ECU 30 obtain information of the setting and cancelation of the test mode, which is transmitted from the test tool 50 via the communication bus 10, and perform the setting and cancelation of the test mode based on the obtained information. The media ECU 20 and the camera ECU 30 are capable of generating an image signal corresponding to an image shown on the display 41.

In the normal mode, the media ECU 20 outputs an image that does not contain a rearward view of the vehicle, such as an image showing the vehicle state or an image showing the media state. The image showing the vehicle state corresponds to, for example, an image showing a state of the air conditioner. The image showing the media state corresponds to, for example, a navigation image or an image showing a function provided by the media ECU 20.

More specifically, the media ECU 20 includes a mode control unit 21, which controls the normal mode and the test mode, a normal mode image generation unit 22, which generates an image for the normal mode, and a test mods image generation unit 23, which generates an image for the test mode.

When the test tool 50 sets the test mode, the mode control unit 21 detects the test made. When the test mode is not detected, the mode control unit 21 sets the normal mode. The mode control unit 21 cancels the test mode based on a cancelation of the test mode performed by the test tool 50 or a condition that may complete the test. The condition that may complete the test is, for example, a system reset of the vehicle display system, deactivation of an ACC power supply (accessory power supply) of the vehicle, or deactivation of an ignition power supply of the vehicle. The mode control unit 21 issues a notification M1 of the setting and cancelation of the test mode to the camera ECU 30 and the display ECU 40.

When the media ECU 20 is in the test mode, the mode control unit 21 selects one of the output image of the media ECU 20 and the output image of the camera ECU 30 as the image shown on the display 41. In the present embodiment, the mode control unit 21 transmits mode notifications M2, M3, which include the setting or cancelation of the test mode and the selection result, to the camera ECU 30 and the display ECU 40, respectively.

When the media ECU 20 is in the normal mode, the normal mode image generation unit 22 generates an image for the normal mode. The media ECU 20 outputs the generated image to the display ECU 40.

When the media ECU 20 is in the test mode, the test mode image generation unit 23 generates an image for the test mode. The media ECU 20 outputs the generated image to the display ECU 40. The test image clearly indicates that the media ECU 20 is in the test mode. For example, the test image may include a message such as “test mode” in emphasis or an image indicative of a test being conducted. Thus, the difference is clarified between the test mode and the normal mode. This obviates a situation in which, for example, the driver is not aware of the test image.

In the normal mode, the camera ECU 30 outputs, for example, the rearward view of the vehicle. However, when the camera ECU 30 detects that the reverse signal is activated via the communication bus 10, the camera ECU 30 generates an image in which an image for assisting in rearward movement of the vehicle is superimposed on the rearward view of the vehicle and outputs the image. When not in the test mode, the camera ECU 30 outputs an image containing the rearward view of the vehicle, which is captured by the camera 31, to the display ECU 40 regardless of whether or not the display 41 shows the output image of the camera ECU 30. This allows the display ECU 40 to promptly switch the image shown on the display 41 from the output image of the media ECO 20 to the output image of the camera ECU 30. Additionally, the camera ECU 30 has a circuit configuration that directly transmits an image capture signal, which contains the rearward view of the vehicle captured by the camera 31, to the display ECU 40 when the camera ECU 30 has a failure such as a power supply interruption or a defect. More specifically, when the transmission is in the reverse gear, the display 41 receives the image capture signal from the camera 31 and shows the rearward view of the vehicle. This limits an occurrence of a failure such that the rearward view of the vehicle is not shown when the vehicle 1 is moved rearward.

The camera ECU 30 includes a mode detection unit 32, which detects the normal mode and the test mode, an assist image generation unit 33, which generates an image that assists in rearward movement of the vehicle 1, and a test mode image generation unit 34, which generates an image for the test mode.

When the test tool 50 sets the test mode, the mode detection unit 32 detects the test mode. When the test mode is not detected, the mode detection unit 32 sets the normal mode. The mode detection unit 32 cancels the test mode based on a cancelation of the test mode performed by the test tool 50, a notification from the media ECU 20, or a condition that may complete the test. The condition that may complete the test is the same as that determined in the mode control unit 21.

When the camera ECU 30 is in the normal mode, the assist image generation unit 33 generates an image in which an image for assisting in rearward movement of the vehicle 1 is superimposed on the rearward view of the vehicle, which is captured by the camera 31 and outputs the image. The image for assisting in rearward movement of the vehicle 1 corresponds to, for example, an image showing a region occupied by the vehicle 1 in the rearward direction.

When the camera ECU 30 is in the test mode, the test mode image generation unit 34 generates a test image, or an image for the test mode. The camera ECU 30 outputs the generated test image. The test mode image generation unit 34 generates, for example, a picture in which a test-related picture, such as a picture having information of sensitivity or luminous intensity or a setting picture, is superimposed on the rearward view of the vehicle captured by the camera 31 instead of superimposing the image for assisting in rearward movement of the vehicle 1 and outputs the generated picture. The test image clearly indicates that the camera ECU 30 is in the test mode. For example, the test image may include a message such as “test mode” in emphasis or an image indicative of a test being conducted. Thus, the difference is clarified between the nest mode and the normal mode. This obviates a situation in which, for example, the driver is not aware of the test image.

The display ECU 40 is connected to the display 41, which is capable of showing an image that includes the rearward view of the vehicle. The display ECU 40 shows an image based on image information received via the image signal lines 13, 14 on the display 41. The display ECU 40 is also connected to a device that detects that the transmission is in the reverse gear. The display ECU 40 is connected to the dedicated signal line 12, which activates the reverse signal when the transmission is in the reverse gear and deactivates the reverse signal when the transmission is not in the reverse gear. The signal line 12 is arranged to decrease the probability of occurrences of delay or incompletion of transmission of the reverse signal. The signal line 12, for example, directly connects the display ECU 40 to the device that detects that the transmission is in the reverse gear.

The display ECU 40 includes a display switch unit 42, which switches the image shown on the display 41.

The display switch unit 42 shows an image on the display 41 based on the activation and deactivation of the reverse signal and one mode notification M3. The mode notification M3 includes the normal mode and the test mode or information related to the result of the output image selected by the media ECU 20.

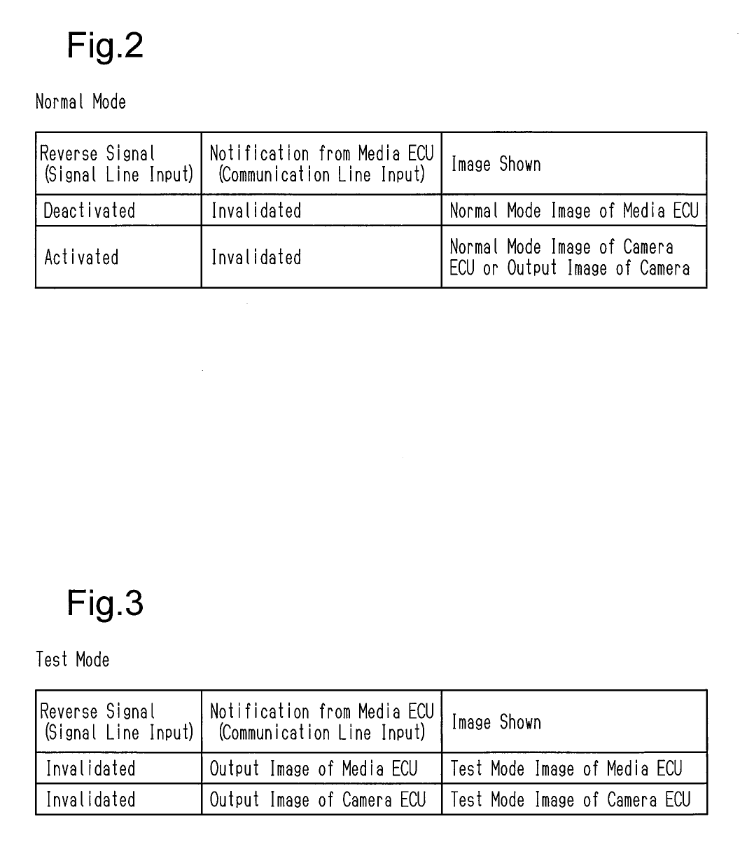

As shown in FIG. 2, when the vehicle display system is in the normal mode, the image selection that is notified from the media ECU 20 to the display ECU 40 is invalidated. The display switch unit 42 switches the image shown on the display 41 based on the reverse signal. More specifically, when the reverse signal is activated, the display ECU 40 shows the output image of the camera ECU 30 on the display 41. When the reverse signal is deactivated, the display ECU 40 shows the output image of the media ECU 20 on the display 41. When the vehicle display system including the media ECU 20 and the camera ECU 30 is in the normal mode, the output image of the media ECU 20 corresponds to the image for the normal mode, and the output image of the camera ECU 30 corresponds to the image for the normal mode or an image based on the image capture signal transmitted from the camera 31.

As shown in FIG. 3, in the present embodiment, when the vehicle display system is in the test mode, the display switch unit 42 shows an image selected by the media ECU 20 on the display 41 regardless of activation or deactivation of the reverse signal. That is, the reverse signal is invalidated. More specifically, when the display switch unit 42 obtains the mode notification M3 and determines that the media ECU 20 selects the output image of the camera ECU 30, the display switch unit 42 shows the output image of the camera ECU 30 on the display 41. When the display switch unit 42 determines that the media ECU 20 selects the output image of the media ECU 20, the display switch unit 42 shows the output image of the media ECU 20 on the display 41. When the media ECU 20 is in the test mode, the output image of the media ECU 20 corresponds to an image for the test mode, and the output image of the camera ECU 30 corresponds to an image for the test mode.

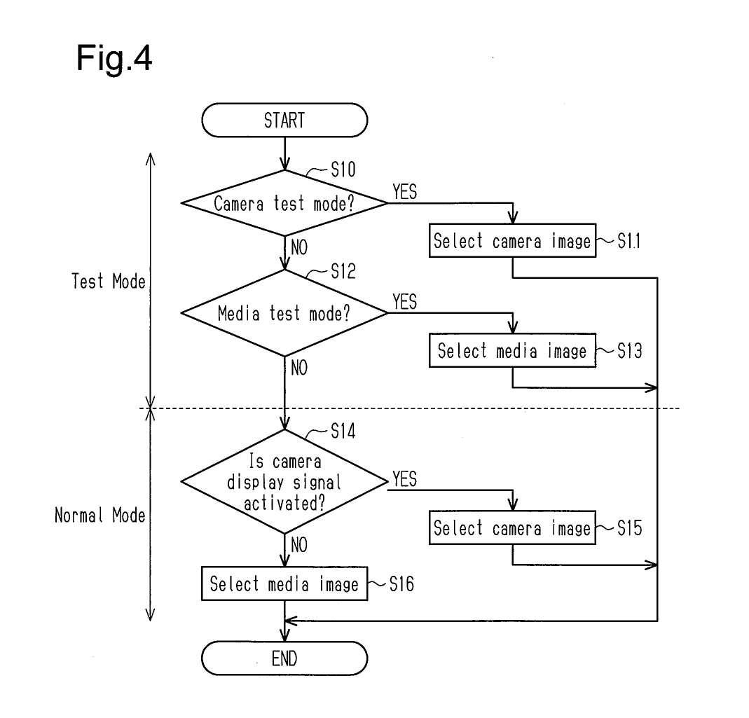

The operation of the display switch unit 42 of the display CCU 40 will now be described with reference to FIG. 4.

The display switch unit 42 executes an image selection process shown in FIG. 4 in predetermined cycles.

The display switch unit 42 determines whether or not the vehicle display system is in a camera test mode based on the mode notification M3 (step S10). In the camera test mode, the vehicle display system is in the test mode, and the media ECU 20 selects the output image of the camera ECU 30. When the display switch unit 42 determines that the vehicle display system is in the camera test mode (YES in step S10), the display switch unit 42 selects the output image of the camera ECU 30 (step S11). Consequently, the display 41 shows the test mode image of the camera ECU 30, which is the output image of the camera ECU 30. The image selection process is then ended.

When the display switch unit 42 determines that the vehicle display system is not in the camera test mode (NO in step S10), the display switch unit 42 determines whether or not the vehicle display system is in a media test mode based on the mode notification M3 (step S12). In the media test mode, the vehicle display system is in the test mode, and the media ECU 20 selects the output image of the media ECU 20. When the display switch unit 42 determines that the vehicle display system is in the media test mode (YES in step S12), the display switch unit 42 selects the output image of the media ECU 20 (step S13). Consequently, the display 41 shows the test mode image of the media ECU 20, which is the output image of the media ECU 20. The image selection process is then ended.

More specifically, the display switch unit 42 executes steps S10 to S13 based on the mode notification M3 transmitted through the information communication line 11. When an abnormality occurs in the process, NO is configured to be selected in steps S10, S12.

When the display switch unit 42 determines that the vehicle display system is not in the media test mode (NO in step S12), the display switch unit 42 determines whether or not a camera display signal is activated (step S14). The activation of the camera display signed, is determined when the reverse signal is activated. When the display switch unit 42 determines that the camera display signal is activated (YES in step S14), the display switch unit 42 selects the output image of the camera ECU 30 (step S15). Consequently, the display 41 shows the normal mode image of the camera ECU 30, which is the output image of the camera ECU 30. The image selection process is then ended.

When the display switch unit 42 determines that the camera display signal is not activated, that is, the reverse signal is deactivated (NO in step S14), the display switch unit 42 selects the output image of the media ECU 20 (step S16). Consequently, tire display 41 shows the normal mode image of the media ECU 20, which is the output image of the media ECU 20. The image selection process is then ended.

More specifically, the display switch unit 42 executes steps S14 to S16 based on the reverse signal transmitted through the dedicated signal line 12. This minimizes effects on the image selection caused by an abnormality occurred in a component other than the display ECU 40.

As described above, the vehicle display system of the present embodiment has the advantages described below.

(1) When the vehicle display system is in the normal mode, if the transmission is shifted to the reverse gear, the image shown on the display 41 is switched from the output image of the media ECU 20 to the rearward view of the vehicle. When the vehicle display system is in the test mode, one of the output image of the camera ECU 30 and the output image of the media ECU 20 selected by the media ECU 20 is shown on the display 41 regardless of whether or not the transmission is in the reverse gear. More specifically, the display 41 maintains the presentation of the image corresponding to the test mode regardless of whether or not the transmission is in the reverse gear. Therefore, when the vehicle 1 is tested, the presentation of the image shown on the display 41 is maintained regardless of whether or not the transmission is shifted to the reverse gear.

When the vehicle 1 is travelable, the media ECU 20 is in the normal mode. Thus, if the transmission is shifted to the reverse gear when the vehicle 1 is travelable, the display 41 always shows the rearward view of the vehicle. This maintains the vehicle travel safety and the compliance with laws and regulations in the same manner as in the prior art.

(2) The media ECU 20 generates a signal (mode notification M3) indicating the normal mode or the test mode based on the signal output from the test tool 50. In the test mode, the media ECU 20 selects whether or not to output the test image of the camera ECU 30. Thus, the image is appropriately switched in the test mode. More specifically, the media ECU 20 generates a signal that indicates the normal mode or the test mode and transmits the signal to the display ECU 40. This allows the display ECU 40 to recognize whether or not the media ECU 20 is in the test mode based on the signal from the media ECU 20.

(3) In the normal mode, the display 41 shows an image output from the media ECU 20 and containing no rearward view of the vehicle or an image output from the camera ECU 30 and containing the rearward view of the vehicle in accordance with whether or not a signal from the dedicated signal line 12 indicates that the transmission is in the reverse gear.

(4) In the test mode, the display 41 shows the test image output, from the media ECU 20 or the test image output from the camera ECU 30. Even when the transmission is shifted to the reverse gear, the image will not be switched. Thus, the presentation of the image is maintained regardless of whether or not the transmission is shifted to the reverse gear. This reduces the burden of testing.

(5) The image shown in the test mode clearly indicates that the vehicle display system is in the test mode. This obviates a situation in which, for example, the driver is not aware of the test image.

(6) When the vehicle display system is not in the test mode, the vehicle display system is always set to the normal mode. More specifically, the test mode will not be set during time of normal traveling. This ensures that the rearward view of the vehicle is shown if the transmission is shifted to the reverse goat when the vehicle is in normal use.

### Other Embodiments

The above embodiment may be modified as follows.

### Media ECU

In the above embodiment, the media ECU 20, the camera ECU 30, and the display ECU 40 are separate from each other. Instead, a single ECU may function as a media ECU, a camera ECU, and a display ECU.

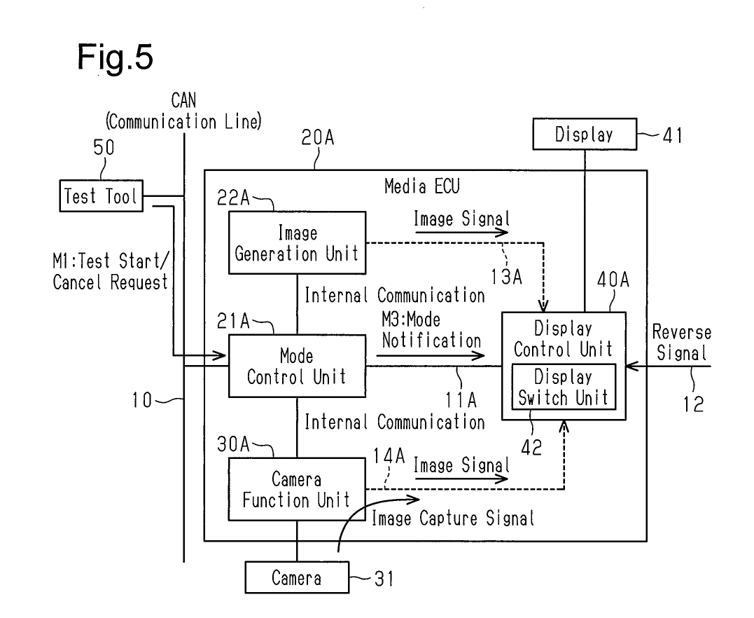

As shown in FIG. 5, the vehicle display system includes the communication bus 10, a media ECU 20A and the test tool 50 communicably connected by the communication bus 10, the dedicated signal line 12 connected to the media ECU 20A, the camera 31, and the display 41. The media ECU 20A includes a mode control unit 21A, an image generation unit 22A, a camera function unit 30A, and a display control unit 40A. The mode control unit 21A has the functions of the mode control unit 21 of the media ECU 20 and the mode detection unit 32 of the camera ECU 30, which have been described. The mode control unit 21A performs internal communication with each of the image generation unit 22A and the camera function unit 30A. The image generation unit 22A has the functions of the normal mode image generation unit 22 and the test mode image generation unit 23, which have been described. Thus, the image generation unit 22A generates an image corresponding to the normal mode or the test mode and outputs the image. The camera function unit 30A has the functions of the assist image generation unit 33 and the test mode image generation unit 34, which have been described. Thus, the camera function unit 30A outputs an image corresponding to the normal mode or the test mode. Additionally, even when the media ECU 20A has a failure such as a power supply interruption or a defect, the camera function unit 30A directly transmits an image capture signal that contains the rearward view of the vehicle captured by the camera 31 to the display control unit 40A. The display control unit 40A is connected to the mode control unit 21A by an information communication circuit 11A. The display control unit 40A is connected to the image generation unit 22A and the camera function unit 30A by image signal circuits 13A, 14A, respectively. When the media ECU 20A has a failure such as a power supply interruption or a defect, the display control unit 40A also directly transmits the image capture signal from the camera 31 to the display 41. Therefore, as long as the camera 31, the display 41, and the reverse signal are normal, an occurrence of a failure such that the rearward view of the vehicle is not shown on the display 41 is limited when the vehicle 1 is moved rearward.

In the above embodiment, the display ECU 40 switches between the output image of the media ECU 20 and the output image of the camera ECU 30. However, when another ECU outputs an image shown on the display 41 in addition to the media ECU 20 and the camera ECU 30, the display ECU 40 may switch between the output image of the ECU, the output image of the media ECU 20, and the output image of the camera ECU 30.

### Camera ECU

In the above embodiment, in the normal mode, the output image of the camera ECU 30 is obtained by superimposing the assist image on the image capture signal transmitted from the camera 31. Instead, in the normal mode, the camera ECU may output an image capture signal transmitted from the camera without superimposing the assist image. In this case, for example, the function for superimposing the assist image may be omitted. Whether or not to superimpose the assist image may be configured to be selectable.

### Communication Protocol

In the above embodiment, the communication protocol uses the CAN protocol. However, if a message counter is used to ensure the reliability of communication messages, the communication protocol may be a protocol other than the CAN protocol. Examples of such protocols include Ethernet (registered trademark) and FlexRay (registered trademark).

Therefore, the present examples and embodiments are to be considered as illustrative and not restrictive and the present disclosure is not to be limited to the details given herein, but may be modified within the scope and equivalence of the appended claims.

1. A vehicle display system comprising:
a display unit configured to show an image;
a camera controller configured to output an image containing a rearward view of a vehicle captured by an onboard camera to the display unit; and
a media controller configured to output an image that does not contain the rearward view of the vehicle to the display unit, wherein
the vehicle display system operates in a normal mode in which the vehicle is travelable and a test mode that differs from the normal mode,
when the vehicle display system is in the normal mode, the display unit is configured to show the output image of the camera controller if the display unit receives a signal indicating that a transmission of the vehicle is in a reverse gear through a signal line, and show the output image of the media controller if the display unit receives a signal indicating than the transmission of the vehicle is not in the reverse gear through the signal line, and
when the vehicle display system is in the test mode, the display unit is configured to show one of the output image of the camera controller and the output image of the media controller that is selected by the media controller regardless of a signal received through the signal line.

2. The vehicle display system according to claim 1, wherein
the media controller is configured to communicate with a test device through a communication line, wherein the test device is used to test the vehicle, and
the media controller is configured to generate one of a signal indicating the normal mode and a signal indicating the test mode and transmit the generated signal to the display unit based on a signal that is output from the test device.

3. The vehicle display system according to claim 2, wherein
the media controller is configured to output the image that does not contain the rearward view of the vehicle to the display unit in accordance with the signal indicating the normal mode,
the camera controller is configured to output the image containing the rearward view of the vehicle to the display unit in accordance with the signal indicating the normal mode,
the display unit is configured to show the output image of the media controller when the display unit receives the signal indicating the normal mode from the media controller and also receives the signal indicating that the transmission is not in the reverse gear from the signal line, and
the display unit is configured to show the output image of the camera controller when the display unit receives the signal indicating the normal mode from the media controller and also receives the signal indicating that the transmission, is in the reverse gear from the signal line.

4. The vehicle display system according to claim 2, wherein
the media controller is further configured to output a test image to the display unit in accordance with the signal indicating the test mode,
the camera controller is further configured to output a test image to the display unit in accordance with the signal indicating the test mode,
the display unit is configured to show the test image output from the media controller when the display unit receives the signal indicating the test mode from the media controller and the media controller selects the image output from the media controller, and
the display unit is configured to show the test image output from the camera controller when the display unit receives the signal indicating the test mode from the media controller and the media controller selects the image output from the camera controller.

5. The vehicle display system according to claim 4, wherein the test image output from each of the media controller and the camera controller in accordance with the signal indicating the test mode specifies the test mode.

6. The vehicle display system according to claim 1, wherein
the normal mode is set when the vehicle display system is not in the test mode, and
the test mode is canceled by a mode cancelation notification from the media controller, a system reset of the vehicle display system, a deactivation of an ACC (accessory) power supply of the vehicle, or a deactivation of an ignition power supply of the vehicle.

7. The vehicle display system according to claim 1, wherein
when the vehicle display system is in the test mode, the media controller is configured to output a test image, which differs from an image output in the normal mode, to the display unit, and
when the vehicle display system is in the test mode, the camera controller is configured to output a test image, which differs from an image output in the normal mode, to the display unit.

8. The vehicle display system according to claim 7, wherein the test image output by the media controller includes a test-related picture superimposed on the rearward view of the vehicle captured by the onboard camera.

9. A method for controlling a vehicle display system that operates in a normal mode in which a vehicle is travelable and a test mode that differs from the normal mode, the method comprising:
showing an image containing a rearward view of the vehicle captured by an onboard camera on a display in accordance with a reception of a signal indicating that a transmission of the vehicle is in a reverse gear through a signal line when the vehicle display system is in the normal mode;
showing an image that does not contain the rearward view of the vehicle on the display in accordance with a reception of a signal indicating that the transmission of the vehicle is not in the reverse gear through the signal line when the vehicle display system is in the normal mode; and
showing an image for the test mode on the display regardless of a signal obtained through the signal line when the vehicle display system is in the test mode.

10. A vehicle display system that operates in a normal mode in which a vehicle is travelable and a test mode that differs from the normal mode, the vehicle display system comprising:
a display configured to show an image; and
circuitry, wherein
when the vehicle display system is in the normal mode, the circuitry is configured to show an image containing a rearward view of the vehicle captured by an onboard camera on the display if the circuitry receives a signal indicating that a transmission of the vehicle is in a reverse gear through a signal line,
when the vehicle display system is in the normal mode, the circuitry is configured to show an image that does not contain the rearward view of the vehicle on the display if the circuitry receives a signal indicating that the transmission of the vehicle is not in the reverse gear through the signal line, and
when the vehicle display system is in the test mode, the circuitry is configured to show an image for the test mode on the display regardless of a signal obtained through the signal line.
